(19) United States
(12) Patent Application Publication
(10) Pub. No.: US 2026/0241650 A1
(43) Pub. Date: Aug. 20, 2026

(54) METHOD FOR MANUFACTURING INSERT MOLDED ARTICLE, MOLD FOR INSERT MOLDING, AND INSERT MOLDED ARTICLE

(71) Applicant: YAZAKI CORPORATION, Tokyo (JP)

(72) Inventors: Shoya Sugiyama, Makinohara-shi (JP); Kazuhiro Tsuchida, Makinohara-shi (JP); Tomohiro Shibata, Makinohara-shi (JP)

(21) Appl. No.: 19/530,378

(22) Filed: Feb. 5, 2026

(30) Foreign Application Priority Data
Feb. 19, 2025 (JP) 2025-024824

(51) Int. Cl. B29C 70/68; B29C 33/14; B29K 705/00; B29L 31/30

(52) U.S. Cl. CPC B29C 70/682; B29C 33/14; B29K 2705/00; B29L 2031/30

(57) ABSTRACT

A method for manufacturing an insert molded article includes an inserting step of disposing a metal collar including a cylinder portion in a first mold such that an axis of the cylinder portion is along a mold clamping direction, a mold clamping step of clamping a second mold including a pressing surface to be in contact with an end surface of the metal collar and the first mold to compress the cylinder portion along the axis and to cause the cylinder portion to bulge into a cavity formed around the cylinder portion by the first mold and the second mold, and a molding step of filling the cavity with a resin.

### CROSS-REFERENCE TO RELATED APPLICATION(S)

The present application claims priority to and incorporates by reference the entire contents of Japanese Patent Application No. 2025-024824 filed in Japan on February 19, 2025.

### BACKGROUND OF THE INVENTION

### 1. Field of the Invention

The present invention relates to a method for manufacturing an insert molded article, a mold for insert molding, and an insert molded article.

### 2. Description of the Related Art

As conventional technologies related to a method for manufacturing an insert molded article, a mold for insert molding, and an insert molded article, for example, Japanese Patent Application Laid-open No. JP 2004 - 042 561 A discloses a method for manufacturing an insert molded article, a mold for insert molding, and an insert molded article in which a collar made of a metallic material having easily deformable portions formed at both ends is set in a mold, an upper mold and a lower mold are brought close to each other to crush the easily deformable portions, and molding is performed with a flat surface formed by the crushing of the easily deformable portions being in close contact with the upper mold or the lower mold.

By the way, such a method for manufacturing an insert molded article, a mold for insert molding, and an insert molded article may be configured such that, for example, the outer circumference of the metal collar is subjected to knurling or the like to prevent it from easily coming loose from a resin molded portion. In addition, there is room for further improvement in the configuration for assembling the metal collar to the resin molded portion.

### SUMMARY OF THE INVENTION

The present invention has been made in view of the above circumstances, and an object thereof is to provide a method for manufacturing an insert molded article, a mold for insert molding, and an insert molded article that can properly assemble a metal collar to a resin molded portion.

In order to achieve the above mentioned object, a method for manufacturing an insert molded article according to one aspect of the present invention includes disposing a metal collar including a tube portion in a first mold such that an axis of the tube portion is along a mold clamping direction; clamping a second mold including a pressing surface to be in contact with an end surface of the metal collar and the first mold to compress the tube portion along the axis and to cause the tube portion to bulge into a cavity formed around the tube portion by the first mold and the second mold; and filling the cavity with a resin. In order to achieve the above mentioned object, a mold for insert molding according to another aspect of the present invention includes a first mold including a placing surface on which an end surface of the metal collar on one side is placed such that an axis of a tube portion of a metal collar including the tube portion is along a mold clamping direction, and a first cavity forming surface adjacent to the placing surface; and a second mold including a pressing surface to be in contact with an end surface of the metal collar on another side, and a second cavity forming surface adjacent to the pressing surface, the first cavity forming surface being formed shallower than the placing surface, and the second cavity forming surface being formed shallower than the pressing surface.

In order to achieve the above mentioned object, a insert molded article according to still another aspect of the present invention includes a metal collar including a tube portion; and a resin molded portion to which the metal collar is assembled, the tube portion including end surfaces on one side and another side along an axis of the tube portion, and a barrel portion between the end surfaces, and the barrel portion bulging outward in a radial direction beyond the end surfaces to bite into the resin molded portion.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of an insert molded article according to an embodiment viewed from above;

FIG. 2 is a perspective view of the insert molded article according to the embodiment viewed from below;

FIG. 3 is a III-III sectional view of FIG. 1;

FIG. 4 is a perspective view of a metal collar assembled to the insert molded article according to the embodiment;

FIG. 5 is a sectional view corresponding to the III-III section of FIG. 1, representing a state in which a first mold and a second mold of a mold for insert molding according to the embodiment are separated from each other and the metal collar is disposed in the first mold;

FIG. 6 is a perspective view of a metal collar support portion of the first mold according to the embodiment;

FIG. 7 is a perspective view of a recessed portion of the second mold according to the embodiment;

FIG. 8 is a flow diagram of a method for manufacturing an insert molded article according to the embodiment; and

FIG. 9 is a sectional view corresponding to the III-III section of FIG. 1, representing a state in which the mold for insert molding according to the embodiment is clamped.

### DETAILED DESCRIPTION OF THE PREFERRED EMBODIMENTS

An embodiment according to the present invention will be described below in detail based on the accompanying drawings. Note that the present invention is not limited by this embodiment. In addition, the components in the following embodiment include ones that are replaceable and easy by those skilled in the art or substantially the same ones.

### Embodiment

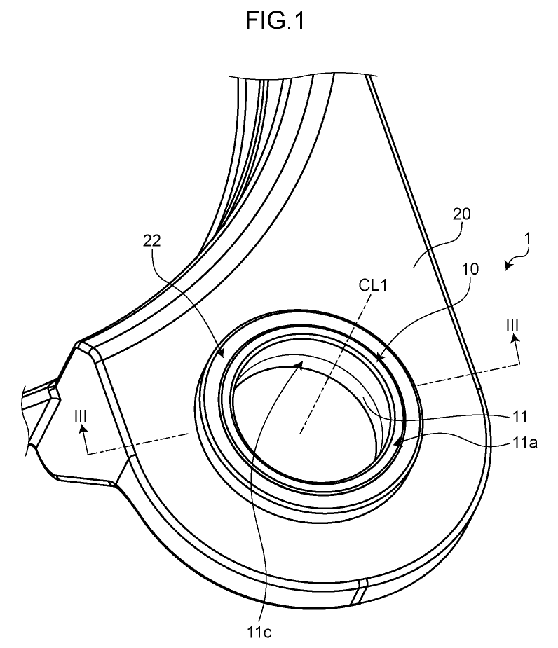

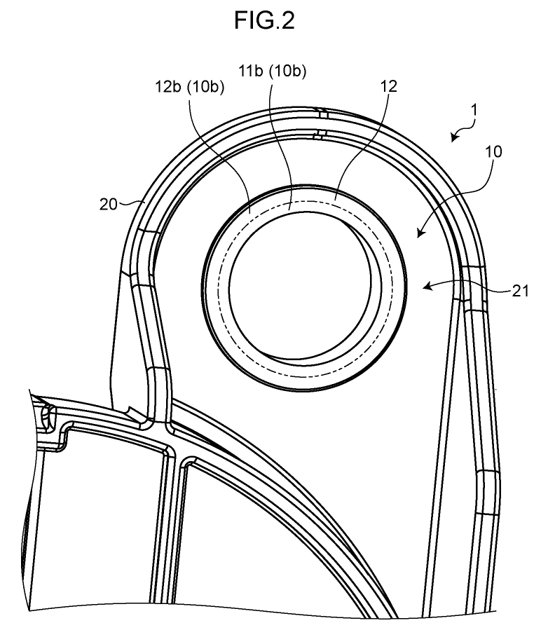

This insert molded article 1 of the present embodiment illustrated in FIG. 1 to FIG. 3 can be, for example, a protector incorporated into a wire harness that is routed to a vehicle such as an automobile. Here, the wire harness, for example, bundles a plurality of routing materials used for power supply and signal communication to make a collective component for connections between devices installed in the vehicle, and connects the routing materials to the devices with connectors or the like. The routing material is, for example, an insulated wire in which a core wire including a plurality of conductive metal wires bundled together is covered with an insulated covering portion. The routing material may be a bundle of a plurality of insulated wires. The protector, which is the insert molded article 1, protects the routing materials routed inside, and is fixed to the vehicle to regulate a routing path for the routing materials.

The protector as the insert molded article 1 includes a metal collar 10 and a resin molded portion 20 that serves as a protector body with the metal collar 10 assembled. The metal collar 10 is made of, for example, a conductive metal material, and is formed in a substantially cylindrical shape around an axis CL1. The metal collar 10 includes a cylinder portion 11 (a tube portion) formed in a substantially cylindrical shape, and a flange portion 12 formed at an end of the cylinder portion 11 on one side in the direction of the axis CL1.

Note that the following description will be given with one side (closer to the flange portion 12) of the metal collar 10 in the direction of the axis CL1 as a lower side and the other side as an upper side.

Although not illustrated, for example, a round terminal of a ground terminal is brought into contact with an upper end surface 11a of the cylinder portion 11 of the metal collar 10, a lower surface 10b of the metal collar 10 including a lower end surface 11b of the cylinder portion 11 and a lower surface 12b of the flange portion 12 is brought into contact with the body of the vehicle or the like, a bolt is inserted into the cylinder portion 11, and thus the insert molded article 1 is fixed to the body of the vehicle or the like together with the ground terminal. This electrically connects the ground terminal to the body of the vehicle or the like via the metal collar 10. The end surface 11a of the cylinder portion 11 and the lower surface 10b of the metal collar 10 are formed in a flat surface shape. Note that the lower surface 10b is formed with the end surface 11b of the cylinder portion 11 and the lower surface 12b of the flange portion 12 being continuous with each other. An upper surface 22 of a resin molded portion 20 around the cylinder portion 11 is positioned on the lower side (the one side) of the upper end surface 11a of the cylinder portion 11. Therefore, the ground terminal is surely made in contact with the end surface 11a of the metal collar 10. The resin molded portion 20 is provided on the upper side of an upper surface 12a of the flange portion 12. Therefore, the flange portion 12 is exposed from a lower surface 21 of the resin molded portion 20.

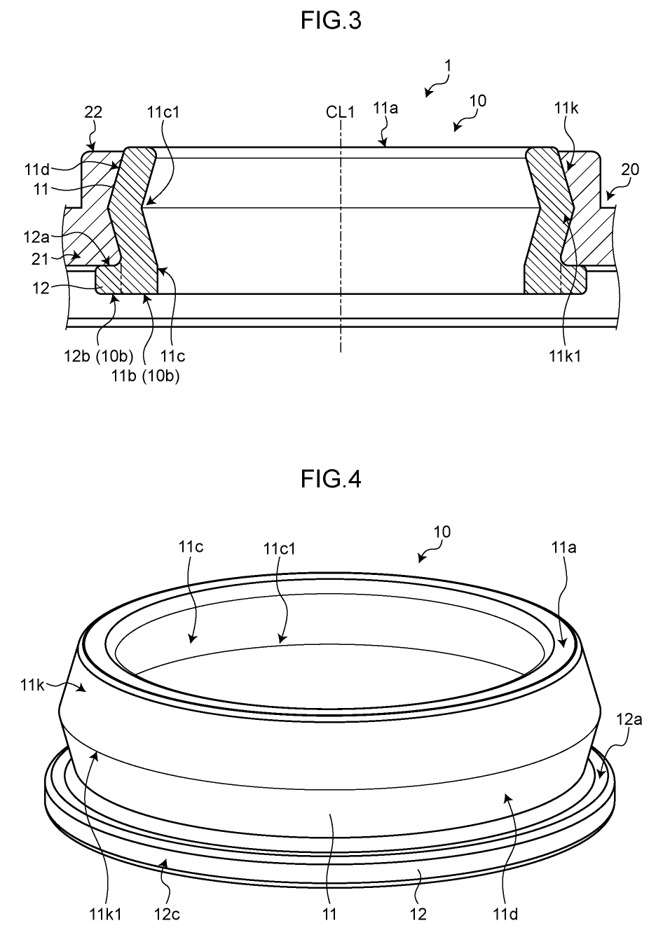

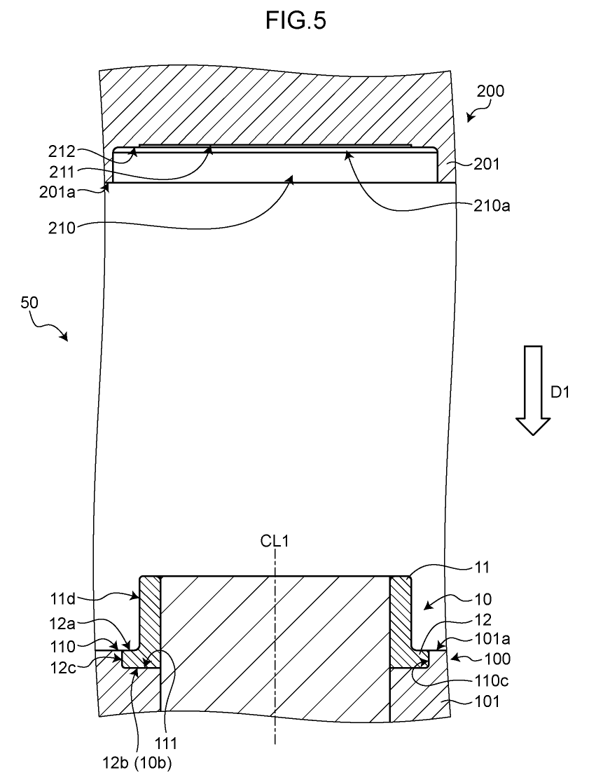

As illustrated in FIG. 3 and FIG. 4, the cylinder portion 11 of the metal collar 10 includes the lower end surface 11b and the upper end surface 11a along the axis CL1, and a barrel portion 11k between the end surface 11b and the end surface 11a. In the present embodiment, the barrel portion 11k is formed by the cylinder portion 11 from the upper end surface 11a to the upper surface 12a of the flange portion 12. The barrel portion 11k includes a bulging portion 11k1 bulging outward in the radial direction (in other words, outward in a direction orthogonal to and intersecting the axis CL1) beyond the end surfaces 11a and 11b. That is, an outer surface 11d (refer to FIG. 5) of the cylinder portion 11 of the metal collar 10 before clamping a first mold 100 and a second mold 200 described below is formed in a linear shape along the axis CL1 from the outer edges of the end surfaces 11a and 11b. The outer surface 11d of the cylinder portion 11 of the metal collar 10 to be assembled to the insert molded article 1 protrudes outward in the radial direction beyond the outer edges of the end surfaces 11a and 11b. In the present embodiment, the bulging portion 11k1 is formed such that the substantially central portion of the length along the axis CL1 from the upper surface 12a of the flange portion 12 to the upper end surface 11a of the cylinder portion 11 bulges outward in the radial direction the most. The bulging portion 11k1 bites into the resin molded portion 20. The bulging portion 11k1 bulging outward in the radial direction is formed in an annular shape. An inner surface 11c of the cylinder portion 11 corresponding to the bulging portion 11k1 is an annular recessed portion 11c1 recessed outward in the radial direction.

In the insert molded article 1, the resin molded portion 20 is disposed on the outer circumference of the cylinder portion 11 around the axis CL1 by insert molding with the metal collar 10 inserted, and the metal collar 10 and the resin molded portion 20 are integrally formed. The upper surface 12a of the flange portion 12 of the metal collar 10 is in contact with the lower surface 21 of the resin molded portion 20. This prevents the metal collar 10 from coming loose in the upward direction.

As illustrated in FIG. 5, a mold 50 for insert molding for manufacturing the insert molded article 1 includes the first mold 100 and the second mold 200. The mold 50 for insert molding can, for example, dispose the first mold 100 on the lower fixed side and dispose the second mold 200 on the upper movable side in a vertical injection molding machine. The first mold 100 and the second mold 200 relatively approach each other to be clamped and relatively separate from each other to be opened. Specifically, the second mold 200 moves from the upper side to the lower side to be clamped as illustrated in a mold clamping direction D1, and moves in a direction opposite to the mold clamping direction D1, that is, from the lower side to the upper side to be opened.

The first mold 100 includes a first mold body 101 and a metal collar support portion 110 provided in the first mold body 101. The upper surface of the first mold body 101 is formed in a flat surface shape to be a first cavity forming surface 101a forming a cavity 250 described below. The metal collar support portion 110 supports the metal collar 10 including the cylinder portion 11. The metal collar support portion 110 is provided in the first cavity forming surface 101a of the first mold body 101.

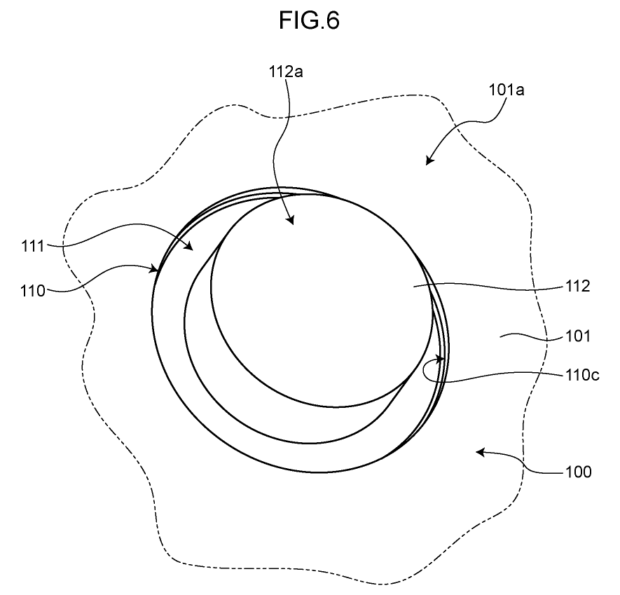

Specifically, as illustrated in FIG. 6, the metal collar support portion 110 includes a placing surface 111 with which the lower surface 10b of the metal collar 10 (that is, the lower end surface of the metal collar 10) is in contact to be placed thereon. The placing surface 111 is formed as a bottom surface of a recessed groove that is annularly recessed from the first cavity forming surface 101a. In the annular inside of the placing surface 111, a support pin 112 formed in a cylindrical shape is formed. The support pin 112 is inserted into the cylinder portion 11 from the underside of the metal collar 10. The length of the support pin 112 along the mold clamping direction D1 is set to a length such that when the metal collar 10 is disposed in the metal collar support portion 110, an upper end surface 112a of the support pin 112 is positioned slightly below the upper end surface 11a of the cylinder portion 11. The metal collar support portion 110 restricts the movement of the metal collar 10 in a direction horizontal to the first cavity forming surface 101a. As illustrated in FIG. 5, the distance from the first cavity forming surface 101a to the placing surface 111 (that is, the depth of the placing surface 111) is made equal to the thickness of the flange portion 12 of the metal collar 10. In other words, the first cavity forming surface 101a, which is provided adjacent to the placing surface 111, is formed shallower than the placing surface 111.

As illustrated in FIG. 5, the second mold 200 includes a second mold body 201. A lower surface 201a of the second mold body 201 is formed in a flat surface shape. The lower surface 201a of the second mold body 201 is a cavity forming surface of the second mold body 201 forming the cavity 250. The lower surface 201a of the second mold body 201 is provided with a recessed portion 210 formed in a substantially circular, recessed shape.

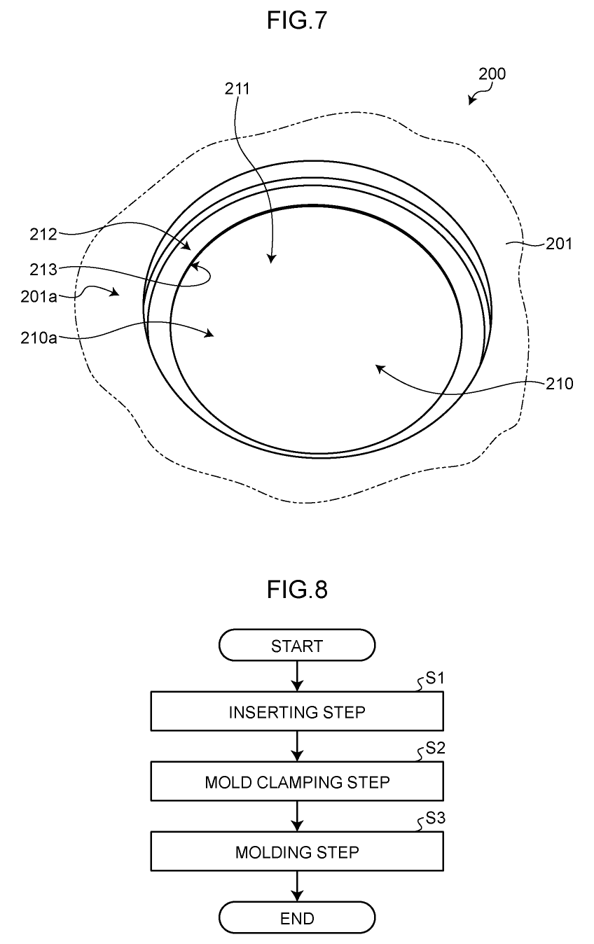

As illustrated in FIG. 7, a bottom portion 210a of the recessed portion 210 is provided with a pressing surface 211 and a second cavity forming surface 212. The pressing surface 211 is formed in a thin circular recessed, substantially flat surface shape. As described below in detail, the pressing surface 211 is in contact with the upper end surface 11a of the metal collar 10 during the clamping of the first mold 100 and the second mold 200. On the other hand, the second cavity forming surface 212 is provided outside the pressing surface 211 in the radial direction. The second cavity forming surface 212 is provided in an annular, flat surface shape adjacent to the outside of the pressing surface 211 in the radial direction, and is formed shallower than the pressing surface 211.

The placing surface 111 of the metal collar support portion 110 and the support pin 112 of the first mold 100 and the pressing surface 211 and the second cavity forming surface 212 of the recessed portion 210 of the second mold 200 are disposed concentrically. In other words, the axis CL1 of the metal collar 10 disposed in the metal collar support portion 110 matches each axis of the placing surface 111 of the metal collar support portion 110 and the support pin 112 of the first mold 100 and the pressing surface 211 and the second cavity forming surface 212 of the recessed portion 210 of the second mold 200, which are made concentric.

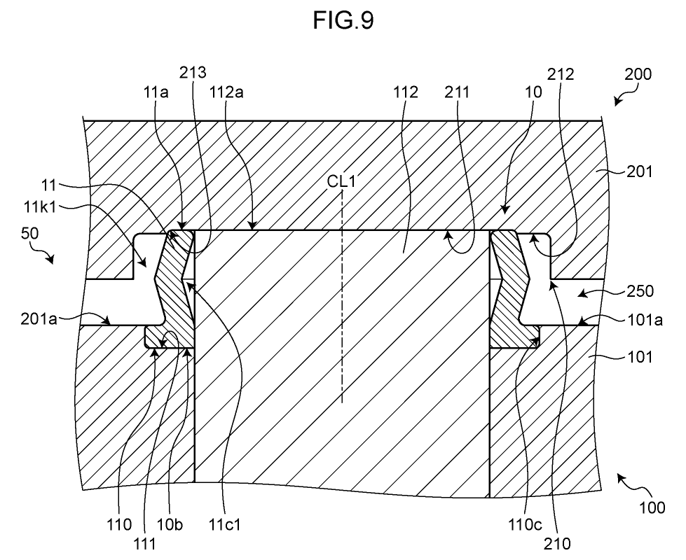

The first mold 100 and the second mold 200 each include a not-illustrated parting surface. The first mold 100 and the second mold 200 are clamped by making them relatively approach each other to bring their parting surfaces into contact with each other. When the first mold 100 and the second mold 200 are clamped, the cavity 250, which is a closed space formed by including the first cavity forming surface 101a of the first mold 100 and the lower surface 201a and the second cavity forming surface 212 of the second mold 200, is formed. The cavity 250 is formed around the cylinder portion 11 of the metal collar 10 disposed in the metal collar support portion 110 of the first mold 100 (on the outer circumference of the cylinder portion 11 around the axis CL1) (refer to FIG. 9).

As illustrated in FIG. 8, a method for manufacturing an insert molded article for manufacturing the insert molded article 1 using the mold 50 for insert molding includes an inserting step (Step S1), a mold clamping step (Step S2), and a molding step (Step S3).

Inserting step (Step S1); As illustrated in FIG. 5, at the inserting step (Step S1), the mold 50 for insert molding is opened, and the metal collar 10 is disposed in the first mold 100 such that the axis CL1 of the cylinder portion 11 is along the mold clamping direction D1. Specifically, the metal collar 10 is disposed in the metal collar support portion 110 of the first mold 100 with the flange portion 12 facing the first mold 100. In this process, the metal collar 10 is disposed such that the lower surface 10b of the metal collar 10, that is, the lower surface 12b as the lower end surface of the flange portion 12 and the lower end surface 11b of the cylinder portion 11 are in contact with the placing surface 111. When the metal collar 10 is disposed in the metal collar support portion 110, the support pin 112 is inserted into the cylinder portion 11 of the metal collar 10. An outer circumferential surface 12c of the flange portion 12 is in contact with a side wall 110c of the metal collar support portion 110 on the outer circumference of the placing surface 111.

Mold clamping step (Step S2); At the mold clamping step (Step S2), after the inserting step (Step S1), the second mold 200 is moved in the mold clamping direction D1 to clamp the first mold 100 and the second mold 200, as illustrated in FIG. 9. Here, the pressing surface 211 of the second mold 200 is in contact with the upper end surface 11a of the cylinder portion 11. The inner circumferential surface of an annular connecting step portion 213 connecting the pressing surface 211 and the second cavity forming surface 212 to each other is in contact with the outer circumferential surface of the cylinder portion 11 closer to the end surface 11a. When the respective parting surfaces of the first mold 100 and the second mold 200 are in contact with each other, the pressing surface 211 and the placing surface 111 put the metal collar 10 therebetween to compress the cylinder portion 11 along the axis CL1. Note that when the respective parting surfaces of the first mold 100 and the second mold 200 are in contact with each other, the upper end surface 112a of the support pin 112 is close to or in contact with the pressing surface 211.

When the cylinder portion 11 is compressed by the pressing of the pressing surface 211, the cylinder portion 11 is bulged into the cavity 250 formed around the cylinder portion 11 at the mold clamping step (Step S2). When the cylinder portion 11 is compressed, the support pin 112 is inserted into the cylinder portion 11, which suppresses radial inward bulging of the cylinder portion 11. The cylinder portion 11 is compressed and bulges to form the bulging portion 11k1. The bulging portion 11k1 is formed by, for example, the cylinder portion 11 compressed and buckled. In this process, the inner surface 11c of the cylinder portion 11 of the metal collar 10 forms the annular recessed portion 11c1 recessed outward in the radial direction corresponding to the outward bulging in the radial direction.

Molding step (Step S3); At the molding step (Step S3), the cavity 250 formed by the mold 50 for insert molding clamped at the mold clamping step (Step S2) is filled with a resin. When the cavity 250 is filled with the resin, the resin molded portion 20 is formed on the outer circumference of the cylinder portion 11. The filled resin is also disposed on the outer circumference of the portion of the cylinder portion 11 bulging outward in the radial direction (the bulging portion 11k1), so that the bulging portion 11k1 bites into the resin molded portion 20.

After the completion of the molding step (Step S3), the second mold 200 is raised to open the first mold 100 and the second mold 200, and the molded insert molded article 1 is taken out of the first mold 100. In this way, the insert molded article 1 can be obtained by the method for manufacturing an insert molded article using the mold 50 for insert molding.

The method for manufacturing an insert molded article described above includes the inserting step (Step S1) of disposing the metal collar 10 including the cylinder portion 11 (the tube portion) in the first mold 100 such that the axis CL1 of the cylinder portion 11 is along the mold clamping direction D1, the mold clamping step (Step S2) of clamping the second mold 200 including the pressing surface 211 to be in contact with the end surface 11a of the metal collar 10 and the first mold 100 to compress the cylinder portion 11 along the axis CL1 and to cause the cylinder portion 11 to bulge into the cavity 250 formed around the cylinder portion 11 by the first mold 100 and the second mold 200, and the molding step (Step S3) of filling the cavity 250 with the resin.

With this, in the insert molded article 1, the cylinder portion 11 of the metal collar 10 is bulged so that it bites into the resin molded portion 20, thereby enabling the metal collar 10 to be assembled to the resin molded portion 20. Therefore, the metal collar 10 is surely prevented from coming loose in the vertical direction owing to the portion bulging and biting into the resin molded portion 20 (the bulging portion 11k1). For example, with the insert molded article 1 as the protector provided in the wire harness installed in the vehicle, the metal collar 10 is fastened to the body of the vehicle together with the ground terminal by the bolt. Also in this case, the insert molded article 1 reduces the possibility of the metal collar 10 easily coming loose from the resin molded portion 20 due to vibration or the like during tightening the bolt or driving the vehicle. Thus, the method for manufacturing an insert molded article of the present embodiment can properly assemble the metal collar 10 to the resin molded portion 20.

That is, according the present embodiment, even when, for example, insert molding that assembles a metal collar of a known form including the cylinder portion 11 and the flange portion 12 to the resin molded portion 20 is performed, the insert molded article 1 in which the metal collar 10 is prevented from coming loose from the resin molded portion 20 can be obtained. Therefore, there is no need to separately perform processing such as knurling on the metal collar.

The first mold 100 includes the support pin 112 to be inserted into the inside of the cylinder portion 11, and the inserting step (Step S1) inserts the support pin 112 into the cylinder portion 11 to dispose the metal collar 10 in the first mold 100. This causes the support pin 112 to restrict radial inward bulging of the cylinder portion 11 when it is compressed, and thus enables the cylinder portion 11 to bulge and bite into the resin molded portion 20 more surely.

The metal collar 10 includes the flange portion 12 formed on the outer circumference of the cylinder portion 11, the first mold 100 includes the placing surface 111 being in contact with the lower surface 12b as the end surface of the flange portion 12, and the mold clamping step (Step S2) puts the metal collar 10 between the pressing surface 211 and the placing surface 111 to compress the cylinder portion 11 along the axis CL1. This can compress the cylinder portion 11 to form the bulging portion 11k1 even in the case where the metal collar 10 is provided with the flange portion 12.

The second mold 200 includes the second cavity forming surface 212 adjacent to the pressing surface 211 and forming the cavity 250, the second cavity forming surface 212 is formed shallower than the pressing surface 211, and the molding step (Step S3) fills the cavity 250 including the second cavity forming surface 212 with the resin. With this, the upper surface 22 of the resin molded portion 20 is positioned on the lower side (the one side) of the end surface 11a of the cylinder portion 11 of the metal collar 10 on the upper (the other side), so that the end surface 11a of the metal collar 10 surely protrudes from the upper surface 22 of the resin molded portion 20, and, for example, the ground terminal can be surely brought into contact with the end surface 11a of the metal collar 10.

The mold 50 for insert molding includes the first mold 100 including the placing surface 111 on which the end surface of the metal collar 10 on one side (the lower side) is placed such that the axis CL1 of the cylinder portion 11 of the metal collar 10 including the cylinder portion 11 is along the mold clamping direction D1, and the first cavity forming surface 101a adjacent to the placing surface 111, and the second mold 200 including the pressing surface 211 to be in contact with the end surface 11a of the metal collar 10 on the other side (the upper side), and the second cavity forming surface 212 adjacent to the pressing surface 211, in which the first cavity forming surface 101a is formed shallower than the placing surface 111, and the second cavity forming surface 212 is formed shallower than the pressing surface 211. This mold 50 for insert molding can compress the cylinder portion 11 of the metal collar 10 to bulge and bite into the resin molded portion 20 to manufacture the insert molded article 1 in which the metal collar 10 is properly assembled to the resin molded portion 20 so as to surely function as the ground terminal.

The insert molded article 1 includes the metal collar 10 including the cylinder portion 11, and the resin molded portion 20 to which the metal collar 10 is assembled, the cylinder portion 11 includes the end surface 11b on one side (the lower side) and the end surface 11a on the other side (the upper side) along the axis CL1 of the cylinder portion 11, and the barrel portion 11k between the end surfaces 11a and 11b, and the barrel portion 11k bulges outward in the radial direction beyond the end surfaces 11a and 11b to bite into the resin molded portion 20. This causes the metal collar 10 of the insert molded article 1 to be properly assembled to the resin molded portion 20 so that it is difficult to come loose from the resin molded portion 20.

Note that the method for manufacturing an insert molded article, the mold for insert molding, and the insert molded article according to the embodiment of the present invention described above are not limited to the embodiment described above, and various changes can be made within the scope described in the claims.

In the above description, the metal collar 10 is provided with the flange portion 12, but a metal collar without the flange portion 12 (that is, including only the cylinder portion 11) can also be used. The metal collar 10 is formed in a substantially cylindrical shape and includes the cylinder portion 11 in the present embodiment, but, for example, one formed in a substantially tubular shape, such as a substantially square tubular shape, can also be employed.

The method for manufacturing an insert molded article, the mold for insert molding, and the insert molded article according to the present embodiment may be configured by combining the components of the embodiment and the modifications described above as appropriate.

The method for manufacturing an insert molded article, the mold for insert molding, and the insert molded article according to the present embodiment has an effect of being capable of properly assembling the metal collar to the resin molded portion.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A method for manufacturing an insert molded article, the method comprising:
disposing a metal collar including a tube portion in a first mold such that an axis of the tube portion is along a mold clamping direction;
clamping a second mold including a pressing surface to be in contact with an end surface of the metal collar and the first mold to compress the tube portion along the axis and to cause the tube portion to bulge into a cavity formed around the tube portion by the first mold and the second mold; and
filling the cavity with a resin.

2. The method for manufacturing an insert molded article according to claim 1, wherein
the first mold includes a support pin to be inserted into an inside of the tube portion, and
the disposing inserts the support pin into the tube portion to dispose the metal collar in the first mold.

3. The method for manufacturing an insert molded article according to claim 1, wherein
the metal collar includes a flange portion formed on an outer circumference of the tube portion,
the first mold includes a placing surface to be in contact with an end surface of the flange portion, and
the clamping puts the metal collar between the pressing surface and the placing surface to compress the tube portion along the axis.

4. The method for manufacturing an insert molded article according to claim 1, wherein
the second mold includes a second cavity forming surface adjacent to the pressing surface and forming the cavity,
the second cavity forming surface is formed shallower than the pressing surface, and
the filling fills the cavity including the second cavity forming surface with the resin.

5. The method for manufacturing an insert molded article according to claim 2, wherein
the second mold includes a second cavity forming surface adjacent to the pressing surface and forming the cavity,
the second cavity forming surface is formed shallower than the pressing surface, and
the filling fills the cavity including the second cavity forming surface with the resin.

6. The method for manufacturing an insert molded article according to claim 3, wherein
the second mold includes a second cavity forming surface adjacent to the pressing surface and forming the cavity,
the second cavity forming surface is formed shallower than the pressing surface, and
the filling fills the cavity including the second cavity forming surface with the resin.

7. A mold for insert molding, the mold comprising:
a first mold including a placing surface on which an end surface of the metal collar on one side is placed such that an axis of a tube portion of a metal collar including the tube portion is along a mold clamping direction, and a first cavity forming surface adjacent to the placing surface; and
a second mold including a pressing surface to be in contact with an end surface of the metal collar on another side, and a second cavity forming surface adjacent to the pressing surface,
the first cavity forming surface being formed shallower than the placing surface, and
the second cavity forming surface being formed shallower than the pressing surface.

8. An insert molded article comprising:
a metal collar including a tube portion; and
a resin molded portion to which the metal collar is assembled,
the tube portion including end surfaces on one side and another side along an axis of the tube portion, and a barrel portion between the end surfaces, and
the barrel portion bulging outward in a radial direction beyond the end surfaces to bite into the resin molded portion.
